(19) United States
(12) Patent Application Publication
(10) Pub. No.: US 2007/0217667 A1
(43) Pub. Date: Sep. 20, 2007

(54) IMAGE PROCESSING DEVICE FOR PROCESSING X-RAY IMAGES

(75) Inventor: Hanns-Ingo Maack, Norderstedt (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/596,464

(22) PCT Filed: Dec. 7, 2004
(86) PCT No.: PCT/IB04/52680

§ 371 Date: Jun. 6, 2007

(30) Foreign Application Priority Data
Dec. 19, 2003 (EP) 03104811.9

(51) Int. Cl. G06T 5/00

(52) U.S. Cl. 382/131

(57) ABSTRACT

The invention relates to an image processing device for processing X-ray images, in particular mammography X-ray images, and also to a corresponding X-ray device, to a method for this and to a computer program or computer program product. In the image processing device, display images are created from X-ray images which show at least two spatially separate objects such as a marker and a mamma Part-images which show the respective objects are determined in the X-ray images and the part-images are arranged in the display images. The size of the display images is such that the part of the display images that is free of the part-images is smaller than the corresponding part of the X-ray images.

The invention relates to an image processing device for processing X-ray images, in particular mammography X-ray images, and also to a corresponding X-ray device, to a method for this and to a computer program or computer program product.

Mammography X-ray devices are used to examine the female breast or mamma. In a mammography X-ray image, the mamma is always shown from an image edge toward the center, that is to say off-center. The rest of the image shows direct radiation. In addition to the mamma, so-called markers are also shown in the mammography X-ray image, said markers containing information about the X-ray image. Known markers absorb X-rays and are applied, before the X-ray image is taken, as a combination of letters and numbers to the X-ray image detector in a corner of the image at the side of the image opposite the mamma. This avoids the image of a marker overlapping the image of the mamma. However, in the case of small mammae, a relatively large image area comprising direct radiation is shown between the image of the marker and the image of the mamma.

In the case of X-ray devices comprising an X-ray image detector, following image acquisition the image data firstly exist in electronic form and are displayed on a monitor or printed onto a film as required. The size of the film used for printing depends on the size of the acquired image. Two film formats are generally used at present, a small format and a large format. The latter is used when the mamma that is to be imaged is too large for a film having the small format. The user of the X-ray device must define the size of the X-ray image prior to acquisition. It sometimes happens that a large X-ray image is selected even though a small one would be sufficient to image the mamma. Consequently, the images of the mamma and of the marker are printed onto too large a film, thereby causing unnecessary costs. When displayed on a monitor, the mamma is displayed unnecessarily small when the overall image is displayed. If the observer zooms into the image area of the mamma, the marker can no longer be seen.

It is therefore an object of the present invention to eliminate these problems.

This object is achieved as claimed in claim 1 by an image processing device for creating a display image from an X-ray image in which at least two spatially separate objects are displayed, wherein part-images which show the objects are determined in the X-ray image and the part-images are arranged in the display image in a spatially separate manner, wherein the size of the display image is such that the part of the display image that is free of the part-images is smaller than the corresponding part of the X-ray image.

The fundamental concept of the invention is to provide the observer no longer with the originally acquired X-ray image but rather to create there from a display image which can then for example be printed onto a film or displayed on a monitor. For this, use is made of an image processing device which firstly analyzes the originally acquired X-ray image, which shows for example a mamma and a marker. Such an image processing device may for example be integrated in an X-ray device, but may also be a device which operates independently of an X-ray device and merely receives X-ray images from the latter, for example a PC or a workstation. The integration of a visualization unit such as a film printer or a monitor is also possible.

The image processing device firstly analyzes the X-ray image and determines therein part-images which respectively show the mamma and the marker. The image of the marker may be derived from a marker which is placed on the X-ray image detector prior to acquisition of the X-ray image. Alternatively, however, the image may also show an artificial, electronically generated marker which is blended into the X-ray image immediately after acquisition by the X-ray device.

The determination of the part-images may be carried out by means of known so-called segmenting methods. These two part-images are then for example pushed together in the display image so that they lie immediately next to one another and thus the size of the image area of the display image is reduced compared to the originally acquired X-ray image. In the process, only information about the image background or direct radiation area which is unimportant to the observer is lost. The part-images show the respective objects with the same resolution and with the same number of pixels as in the X-ray image, whereas the display image itself is smaller or has a smaller image area than the X-ray image on account of a lower number of pixels.

It is thus possible to show the observer all the essential information, namely the part-images, on an image area of the display image which is reduced in size compared to the originally acquired X-ray image. If the display image is displayed on a monitor, wherein each pixel of the display image corresponds to a pixel on the monitor, it may happen that the complete display image can be shown on the monitor, whereas the X-ray image cannot. If the entire X-ray image is to be shown, it must necessarily be shown smaller, so that the objects of interest to the observer are also shown smaller too. If the display image is smaller than the largest image that can be displayed on the monitor, the display image may even be shown enlarged. In the case of printing onto a film, it is also possible to print originally large-format X-ray images onto small-format films, without the scale of the image being reduced during printing.

By virtue of the smaller part of the image area that is free of the part-images, the amount of image data of a display image is smaller than that of the X-ray image, so that further positive effects are achieved in addition to achieving the abovementioned object. For subsequent electronic image processing, less processor power is required so that such an image processing system operates more rapidly or can be designed with a lower capacity. When transmitting the display image to another system such as a film printer or a monitor, compared to the originally acquired X-ray image less image data have to be transmitted, so that here too there is a saving in terms of time. Less memory space is required to store the display image, for example in an electronic image archive.

The object is furthermore achieved as claimed in claim 2 by an X-ray device comprising:
an X-ray source for generating X-ray radiation,
an X-ray image detector for acquiring X-ray images,
an image processing device for creating a display image from an X-ray image in which at least two spatially separate objects are displayed, wherein part-images which show the objects are determined in the X-ray image and the part-images are arranged in the display image in a spatially separate manner, wherein the size of the display image is such that the part of the display image that is free of the part-images is smaller than the corresponding part of the X-ray image.

In order to acquire an X-ray image of objects, the X-ray source generates X-ray radiation which is attenuated as it penetrates the objects and reaches the X-ray image detector. It is possible to use for example, as X-ray image detector, X-ray image amplifiers, known digital X-ray image detectors or even memory films with an appropriate reader. Following acquisition, part-images which show the imaged objects are determined in the X-ray image. The part-images are arranged in a display image such that the area comprising image background is smaller than in the X-ray image. The display image may then be forwarded to a visualization unit, for example a film printer or a monitor. Particularly in a hospital with electronic administration of patient data, however, the display image may also be passed to a central computer which archives it. If the user of the X-ray device would like to view the image, he can load it from the electronic archive onto a viewing station and print it out or view it there.

The dependent claims contain developments of the invention.

X-ray systems are known in which the size of the detector surface area irradiated by X-ray radiation is usually only as large as the size of the image that is to be acquired, so that in the case of small-format images the entire detector surface is not irradiated. In certain types of digital X-ray detectors, irradiated areas remain stored in the detector on account of a number of known physical effects, whereby last-acquired small-format images can be seen in subsequent large-format images as “ghost images”. This effect is particularly disruptive in the case of mammography X-ray images since an area comprising direct radiation directly adjoins a non-irradiated detector area. This effect would not be disruptive if the entire detector surface area were to be exposed to X-ray radiation when each image is taken. However, this would lead to all the X-ray images being large and to large-format films always having to be used for printing, and this is not viable for reasons of economy. When displaying such a large X-ray image on the monitor, the mamma would be shown much too small.

In the X-ray device according to the invention, the image size of the acquired X-ray image need no longer be minimized so that, particularly in the case of mammography images, the image area comprising direct radiation may be of any size. The irradiated surface area of the X-ray image detector therefore need also no longer be adapted to the size of the mamma or to the size of the film used for printing. Instead, as claimed in claim 3, the X-ray device is set such that the same surface area, for example the entire surface area, of the X-ray image detector is irradiated each time an image is taken. When using a marker, this is always positioned at the same point. This saves time for the user of the X-ray device since he need no longer decide beforehand between large-format and small-format images. Furthermore, disruptive effects caused by “ghost images” are considerably reduced since there are no longer any areas of the X-ray detector that are not irradiated.

It may be unpleasant for an observer if the part-images have been positioned to close to one another in the display image. This can be avoided with the embodiment as claimed in claim 3. For individual setting, it is also possible for the minimum spacing to be defined by the observer.

The abovementioned object is also achieved by a method as claimed in claim 7. The development as claimed in claim 8 makes it possible for the part of the display image that is free of the part-images to be matched to the background of the X-ray image.

In order to determine the part-images, use may be made for example of known segmenting methods. In the case of mammography X-ray images, the segmenting method as claimed in claim 9 provides particularly rapid results since it takes up little computation time. In this case, the background image area which shows direct radiation is determined in the X-ray image. The remaining parts of the X-ray image then form the part-images.

The image processing device may be formed by appropriate electronic components such that it cannot be modified in terms of its function. Alternatively, it may have a programmable arithmetic unit which has to be placed in the operating state prior to startup by a corresponding computer program. Such a computer program may be stored in a non-volatile and non-interchangeable memory which is located in the device. Alternatively, however, the computer program may also be loaded into the image processing device by means of a reader which can read a computer program product such as a floppy disk, CD or even an EPROM.

The invention will be further described with reference to examples of embodiments shown in the drawings to which, however, the invention is not restricted.

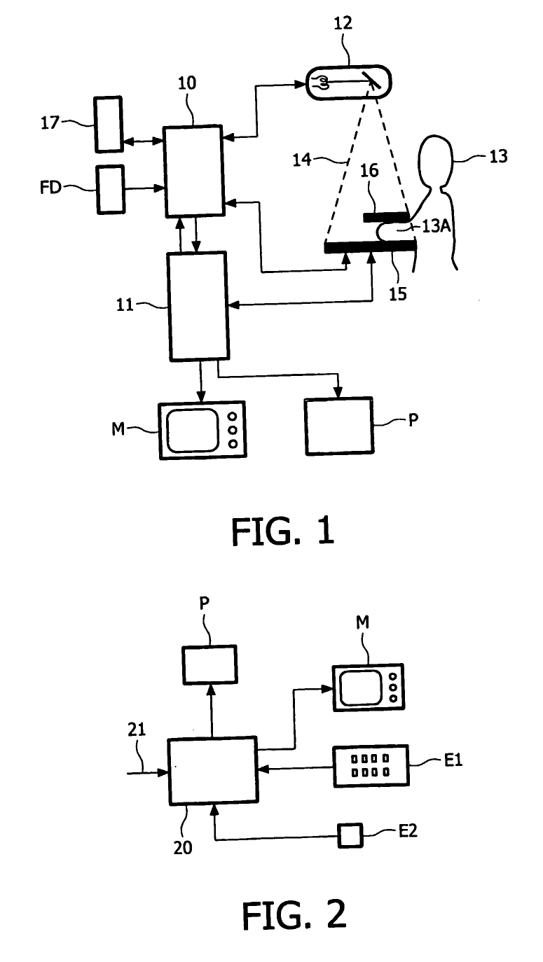

FIG. 1 shows an embodiment of the X-ray device according to the invention.

FIG. 2 shows a data processing system comprising an image processing device according to the invention.

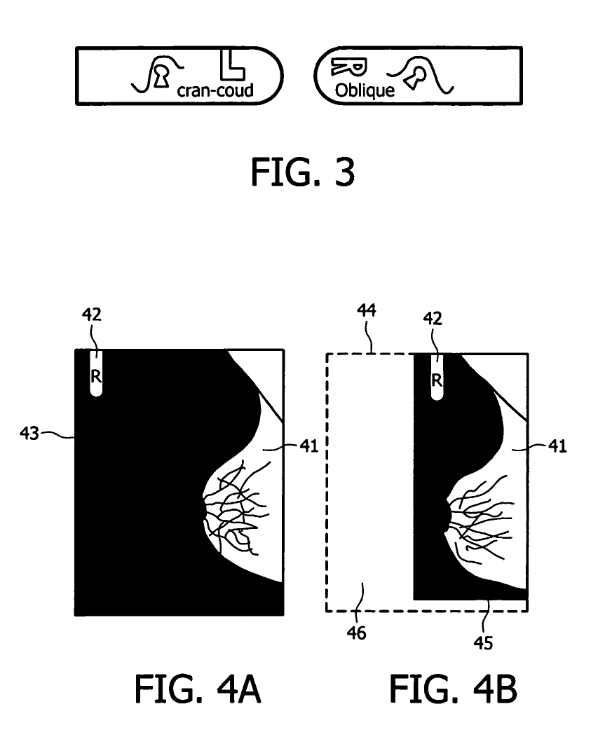

FIG. 3 shows two markers.

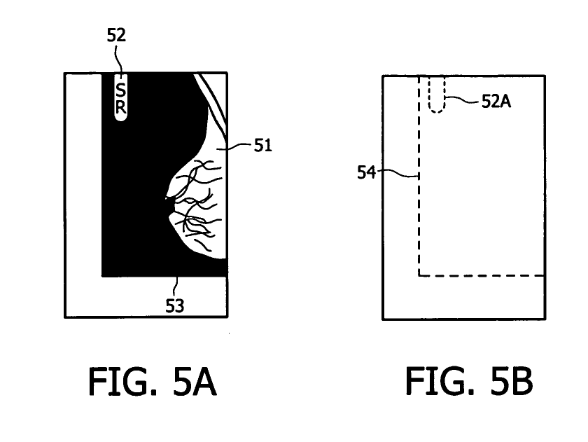

FIGS. 4A, 4B and 5A schematically show mammography X-ray images.

FIG. 5B shows disruptive effects in images of an X-ray image detector.

FIG. 1 schematically shows an X-ray device according to the invention which can be used to create mammography X-ray images. The patient 13 to be examined stands in front of a table (not shown) which can be adjusted in terms of its height such that a mamma 13A of the patient 13 lies thereon. Below the table there is a digital X-ray image detector 15. The table and the detector may alternatively form a unit by the housing of the detector being designed appropriately. In order to be better able to see details in the X-ray image, a compression plate 16 presses on the mamma such that the latter is widened, compared to its natural shape, parallel to the X-ray image detector. The compression plate 16 is made of a material which does not absorb X-ray radiation or absorbs it only very slightly.

By way of preparation, firstly application-specific parameters such as X-ray voltage, current and duration are set via an operating unit 17. A marker is then placed in a corner on the side of the table or detector opposite the mamma or in a special holder. Such markers are shown in FIG. 3. The symbols shown therein indicate for example whether the left or right mamma is being imaged and in which direction the X-rays have passed through the mamma.

In order to acquire an X-ray image, a control unit 10 then switches the X-ray image detector 15 and an X-ray tube 12 into the corresponding operating state. Further components such as an X-ray generator, which generates the high voltage required for operation of the X-ray tube 12, are not shown for the sake of clarity. X-rays in the form of a cone-shaped bundle of rays 14 are generated in the X-ray tube. By virtue of screens (not shown) which are arranged immediately below the X-ray tube 12, the size and outer shape of the beam cone 14 can be adjusted and for example adapted to the size and shape of the X-ray image detector 15. Once irradiation is complete, an electronic digital X-ray image then exists in the digital X-ray image detector 15, and this X-ray image is transmitted—in a manner controlled by the control unit 10—from the X-ray image detector 15 to the image memory of an image processing device 11. Alternatively, it is also possible to use a memory film system as X-ray detector. The memory film is then read by a special reader once the image has been taken, and the X-ray image exists in electronic form in this case too.

As already mentioned above, the outer shape of the beam cone 14 can be changed by means of screens so that the entire surface of the X-ray detector 15 is no longer irradiated. In this way, in some of the systems known to date the size of the X-ray image is adapted to the size of the films used for printing. For most images, it is sufficient to acquire a small image as shown in FIG. 5A. The image of the marker 52, the image of the mamma 51 and the background 53 can be seen in said FIG. 5A. If a large image has to be acquired on account of the size of the mamma, the screens are adjusted accordingly and the marker is positioned, instead of at the outer image edge of the small image, now at the outer edge of the large image. However, in the operations of acquiring small images that were previously carried out, the X-ray image detector 15 was exposed to a high accumulated dose of radiation in the direct radiation area. On account of known physical effects, these areas can be seen in the subsequently acquired large images, as shown by dashed lines in FIG. 5B. It may still be possible to see these effects in a large image even days after the last time a small image was taken.

In the X-ray device of FIG. 1, such effects can be avoided in that the outer shape of the beam cone 14 is the same for all images (e.g. the same detector surface area), so that the same area of the X-ray image detector 15 is always irradiated. In order to print the image onto small-format films, a corresponding small-format display image is then created as described above.

FIG. 4A schematically shows an X-ray image as can be acquired using the X-ray device of FIG. 1. The image of the mamma 41 can be seen in the right-hand half of the image and the image of the marker 42 can be seen in the upper left-hand corner. The rest of the image area 43 which forms the background shows direct radiation and is therefore almost black. In the image processing device 11, the X-ray image is segmented in order to determine the part-images. For this, use may be made of known segmenting methods as described, for example, in the book by Alan C. Bovik, “Handbook of Image and Video Processing”, ISBN: 0121197905. Since such segmenting methods are known and moreover there are so many different such methods, only one will be described below by way of example.

Firstly, a histogram is determined from the X-ray image. In the case of mammography X-ray images, image values which are to be assigned either to the objects or to the background can be distinguished particularly easily from the histogram since the background is formed by direct radiation and the corresponding image value greatly differs from object image values. Moreover, all pixels comprising direct radiation usually have almost the same image value, which may vary only slightly by the quantum noise of direct radiation. In the X-ray image in FIG. 4A, all the pixels with the image value or values determined in this way are assigned to the background area 43. As a further criterion, these pixels must form one or more coherent areas in order to avoid the situation where individual pixels of the objects which also have the image value of direct radiation are assigned to the background area.

By virtue of this method, the X-ray image of FIG. 4A is segmented into three areas, namely the background area 43, the image area of the image of the marker 42 and the image area of the image of the mamma 41. Two image areas or part-images can then be identified there from, namely those which contain pixels whose image values do not represent direct radiation. A first part-image contains the image of the mamma 41 and is delimited by the outer contour thereof and the right-hand edge of the image. The second part-image contains the image of the marker 42 which is delimited by the outer contour thereof and the upper edge of the image. This method can also be used when the marker is placed on the X-ray image detector at an angle such that the image thereof is delimited by two image edges and there is a separate image area comprising direct radiation in the corner of the image delimited thereby. The X-ray image is then segmented into four areas, two background areas and two part-images.

These two part-images can then be moved such that the part-image comprising the marker is pushed as close as possible to the part-image comprising the mamma. To do this, for example the pixels of the part-image comprising the marker are moved to the right in stages until at least one pixel of the part-image comprising the marker and one pixel of the part-image comprising the mamma are directly adjacent. If this part-image comprising the marker is not delimited by the upper edge of the image, it may also additionally be moved upward. A rectangular area which large enough that all the part-images are located therein is defined as the edge of the display image. The remaining outer areas 46 are then removed and the display image of FIG. 4B is obtained. For illustration and comparison purposes, the original image edge 44 of the X-ray image of FIG. 4A is shown in dashed line. Optionally, the part-images may also be designed such that they are rectangular, their edges run parallel to those of the X-ray image and they are just large enough that the correspondingly segmented image areas fit. These rectangular part-images are then pushed so close to one another that they just touch one another. The processing steps described above are carried out automatically by the image processing device.

For the observer of the display image, it may be unpleasant if the image of the marker and the image of the mamma are too close together. In order to avoid this, it is possible to define for example a minimum distance by which the part-images must be spaced apart. Alternatively, each part-image may be expanded by a border prior to being moved. The width of this border is selected such that the border is visible to the observer; it may optionally be set by the user.

The outer dimensions of the display image are at least large enough that the two part-images can be displayed without overlapping. However, it is also possible to make the outer dimensions greater and for example to adapt them to the size of a film used for printing or to the size of a monitor.

There are a number of possibilities for forming the background 45 of the display image of FIG. 4B. For example, a mean value can be determined from the background of the X-ray image, and this mean value is used as the image value for all the pixels of the display image of FIG. 4B, so that a homogeneous background with approximately the gray value of the background of the X-ray image is produced. Another possibility consists in transferring the pixels of the background from the X-ray image into the display image, provided they are present in the remaining background area 45. Other alternatives are conceivable.

Once creation of the display image is complete, in FIG. 1 the display image can be optionally passed to a monitor M or to a film printer P.

Depending on the complexity of the image processing device 11, it is possible to implement further image processing algorithms. If the marker is positioned manually on the X-ray image detector 15 prior to the image being taken, it may happen that said marker does not lie with its long side parallel to the edge of the image. For correction purposes, use may be made of a detection algorithm which automatically detects the marker as such and aligns its image parallel to the edge of the display image by rotation. It is also possible to detect the information contained in the marker by means of corresponding algorithms and to pass the display image for example automatically to a corresponding electronic image archive.

The image processing device 11 contains an arithmetic unit (not shown) which can be programmed. Once the X-ray device has been switched on, the arithmetic unit must firstly be loaded with a corresponding computer program. The computer program is stored on a floppy disk which has to be inserted into a corresponding reader FD in order to be read. Alternatively, the computer program may also be stored in a non-volatile memory which is located in the image processing device 11 and is automatically read once the X-ray device has been switched on.

FIG. 2 shows a data processing system with one embodiment of the image processing device according to the invention. Such a system can be used, for example, wherever a physician would like to view an X-ray image away from the location at which it was acquired, in particular when the physician is working in a location that is spatially separate from the X-ray device, as may be the case in large hospitals. Firstly, an X-ray image is acquired by means of an X-ray device as shown in FIG. 1, but the X-ray device has no image processing device 11. Instead, the X-ray image is sent for example over a data network to the data processing system of FIG. 2 and passes into the image processing device 20 via a data input 21.

The image processing device 20 in principle has the same functionality as the image processing device 11 of FIG. 1. In the input X-ray image, part-images which show objects are determined and are arranged in a display image. The display image can then be displayed on a monitor M or be printed onto a film by means of a printer P. The image processing device 20 is operated by means of a keyboard E1 and a mouse E2. In a manner analogous to FIG. 1, the image processing device 20 may also be designed such that it can be programmed.

1. An image processing device for creating a display image from an X-ray image in which at least two spatially separate objects are displayed, wherein part-images which show the objects are determined in the X-ray image and the part-images are arranged in the display image in a spatially separate manner, wherein the size of the display image is such that the part of the display image that is free of the part-images is smaller than the corresponding part of the X-ray image.

2. An X-ray device comprising:
an X-ray source for generating X-ray radiation,
an X-ray image detector for acquiring X-ray images,
an image processing device for creating a display image from an X-ray image in which at least two spatially separate objects are displayed, wherein part-images which show the objects are determined in the X-ray image and the part-images are arranged in the display image in a spatially separate manner, wherein the size of the display image is such that the part of the display image that is free of the part-images is smaller than the corresponding part of the X-ray image.

3. An X-ray device as claimed in claim 2, wherein in each case the same surface area of the X-ray image detector is exposed to X-ray radiation as the X-ray images are being created.

4. An image processing device as claimed in claim 1, wherein the part-images are spaced a minimum distance apart in the display image.

5. An image processing device as claimed in claim 1, wherein the X-ray images are mammography X-ray images.

6. An image processing device as claimed in claim 1, wherein one of the objects shown is a marker.

7. A method of creating a display image from an X-ray image, comprising the following steps:
a) determining part-images, which each show an object, in the X-ray image,
b) arranging the part-images in the display image in a spatially separate manner,
c) dimensioning the size of the display image such that the part of the display image that is free of the part-images is smaller than the corresponding part of the X-ray image.

8. A method as claimed in claim 7, comprising the further step:
d) filling the part of the display image that is free of the part-images with image information from the part of the X-ray image that is free of the part-images.

9. An image processing device as claimed in claim 1, wherein in order to determine the part-images use is made of a segmenting method in which the image values of the part of the X-ray image that is free of the part-images are determined and a coherent image area which contains mainly pixels with these image values is determined in the X-ray image.

10. A computer program or computer program product for an image processing device as claimed in claim 1 for carrying out a of creating a display image from an X-ray image, comprising the following steps:
a) determining part-images, which each show an object, in the X-ray image,
b) arranging the part-images in the display image in a spatially separate manner,
c) dimensioning the size of the display image such that the part of the display image that is free of the part-images is smaller than the corresponding part of the X-ray image.
